(19) United States
(12) Patent Application Publication
(10) Pub. No.: US 2008/0259947 A1
(43) Pub. Date: Oct. 23, 2008

(54) Method and System for High-Concurrency and Reduced Latency Queue Processing in Networks

(75) Inventor: Rajaram B. Krishnamurthy, Adliswil (CH)

Correspondence Address: GEORGE A. WILLINGHAN, III;AUGUST LAW GROUP, LLC, P.O. BOX 19080, BALTIMORE, MD, 21284-9080, US

(73) Assignee: INTERNATIONAL BUSINESS MACHINES CORPORATION, Armonk, NY (US)

(21) Appl. No.: 12/168,029

(22) Filed: Jul. 3, 2008

Related U.S. Application Data
(63) Continuation of application No. 11/362,683, filed on Feb. 27, 2006.

(51) Int. Cl. H04L 12/56

(52) U.S. Cl. 370/412; 370/465

(57) ABSTRACT

A method and a system for controlling a plurality of queues of an input port in a switching or routing system. The method supports the regular request-grant protocol along with speculative transmission requests in an integrated fashion. Each regular scheduling request or speculative transmission request is stored in request order using references to minimize memory usage and operation count. Data packet arrival and speculation event triggers can be processed concurrently to reduce operation count and latency. The method supports data packet priorities using a unified linked list for request storage. A descriptor cache is used to hide linked list processing latency and allow central scheduler response processing with reduced latency.

The method further comprises processing a grant of a scheduling request, an acknowledgement of a speculation request or a negative acknowledgement of a speculation request. Grants and speculation responses can be processed concurrently to reduce operation count and latency. A queue controller allows request queues to be dequeued concurrently on central scheduler response arrival. Speculation requests are stored in a speculation request queue to maintain request queue consistency and allow scheduler response error recovery for the central scheduler.

### FIELD OF THE INVENTION

The present invention relates generally to interconnection networks like switching and routing systems and more specifically, to a method and a system for arranging input queues in a switching or routing system for processing scheduled arbitration or speculative transmission of data packets in an integrated fashion with high concurrency and reduced latency.

### BACKGROUND OF THE INVENTION

Switching and routing systems are generally a part of communication or networking systems organized to temporarily associate functional units, transmission channels or telecommunication circuits for the purpose of providing a desired telecommunication facility. A backplane bus, a switching system or a routing system can be used to interconnect boards. Routing systems provide end-to-end optimized routing functionality along with the facility to temporarily associate boards for the purposes of communication using a switching system or a backplane bus. Switching or routing systems provide high flexibility since multiple boards can communicate with each other simultaneously. In networking and telecommunication systems, these boards are called line-cards. In computing applications, these boards are called adapters, blades or simply port-cards. Switching systems can be used to connect other telecommunication switching systems or networking switches and routers. Additionally, these systems can directly interconnect computing nodes like server machines, PCs, blade servers, cluster computers, parallel computers and supercomputers.

Compute or network nodes in an interconnection network communicate by exchanging data packets. Data packets are generated from a node and are queued in input queues of a line-card or a port-card of a switching system. The switching system allows multiple nodes to communicate simultaneously. If a single FIFO (First In First Out) queue is used in an input port to queue data packets, then the HOL (Head-of-Line) data packet in the input queue can delay service to other data packets that are destined to output ports different from the HOL data packet. In order to avoid this, existing systems queue data packets in a VOQ (Virtual Output Queue). A VOQ queues data packets according to their final destination output ports. There is a queue for every output port. A link scheduler can operate on queues in a round-robin fashion to provide fair service to all arriving data packets. In switching systems with a switch fabric and central scheduler, data packet arrival information is communicated to a central scheduler. The central scheduler resolves conflicts between data packets destined to the same output port in the same time-step and allocates switch resources accordingly. The central scheduler is responsible for passage of data packets from the input port (a source port) to the output port (the destination port) across the switching fabric.

FIG. 1 is a block diagram showing a conventional arrangement of a switching system with port-cards, switching fabric and central scheduler. The switching system typically comprises a switching fabric 105 and a central scheduler or a central arbiter 110. A plurality of input ports, A₁ 115 to A_{N} 120, carry data packets that are desired to be sent across to any of the plurality of output ports, C₁ 125 to C_{N} 130. Each input port has VOQs corresponding to each output port. For example, input port A₁ 115 has VOQs corresponding to each of the N output ports as shown at 135 and input port A_{N} 120 has VOQs corresponding to each of the N output ports as shown at 140. A data packet that is scheduled to be transmitted from an input port is transferred to switching fabric 105 over data channels B₁ 145 to B_{N} 150 corresponding to input ports A₁ 115 to A_{N} 120. Central scheduler 110 is responsible for scheduling the data packets and controlling their transmission from the input ports to the output ports. Central scheduler 110 communicates with input ports A₁ 115 to A_{N} 120 over control channels CC₁ 155 to CC_{N} 160 for scheduling the data packets.

Switching fabric 105 can be a crossbar fabric that can allow interconnection of multiple input ports and output ports simultaneously. A crossbar switching system is a switch that can have a plurality of input ports, a plurality of output ports, and electronic means such as silicon or discrete pass-transistors or optical devices, for interconnecting any one of the input ports to any one of the output ports. In some of the existing switching systems, descriptors are generated and queued in VOQs according to their destination output ports, while data packets are stored in memory. Descriptors are references or pointers to data packets in memory and might contain data packet addresses and other relevant information. Relevant information from these descriptors is forwarded to the centralized scheduler for arbitration. A system may choose to queue a data packet directly in the VOQ along with other useful information or queue a descriptor, for example a reference to the data packet in the VOQ.

In some of the existing switching and routing systems, a Head-of-Line (HOL) data packet in an input queue of a line-card or a port-card issues a request to central scheduler 110 using control channels (for example CC₁ 155 to CC_{N} 160 in FIG. 1) to provide a path through switching fabric 105. Central scheduler 110 matches inputs and outputs and returns a grant to the input queue when passage to the output port across switching fabric 105 is possible. The HOL data packet is then transmitted along the data channel (example B₁ 145 to B_{N} 150 in FIG. 1) to switching fabric 105 so that the data packet can be switched to the appropriate output port by action of central scheduler 110. Such a request made by the data packet is termed in existing systems as a “regular”, “computed” or “deterministic” scheduling request or simply called “scheduled arbitration”. The process of line-card request and central scheduler action is sometimes called a “request-grant” cycle.

FIG. 2 is a block diagram of a conventional input port with a link scheduler. For example, input port 205 can be any one of the input ports A₁ 115 to A_{N} 120 in FIG. 1. Data packets enter the input port from an external link 210. These data packets are then demultiplexed using a demultiplexer 215, and the data packets are enqueued into VOQs corresponding to the appropriate output ports. FIG. 2 depicts a plurality of VOQs for example, VOQ Output1 220 corresponding to output port 1 and VOQ OutputN 225 corresponding to output port N. When a grant for a data packet enqueued in any one of the N VOQs is received, the data packet is forwarded to switching fabric 105 via the data channel link 235 corresponding to the port-card where the data packet is enqueued. Switching fabric 105 switches the data packet to its destined output port. A copy of the data packet is copied to a retransmission or retry queue labeled RTR in FIG. 2. This copy is released when an acknowledgement corresponding to receipt of the data packet at the output port is received. The RTR queue is used for retransmission of lost or corrupted packets. For example, after a data packet is transmitted to the switching fabric from Output1 220, a copy of the data packet is placed in RTR1 queue 255 until an acknowledgement is received. The link scheduler 245 is used to select from any of VOQ Output1 to VOQ OutputN using a round-robin or suitable scheduling policy. The selected queue makes a scheduling request corresponding to the HOL (Head-of-Line) packet in the queue. There is a single data channel link from any port card to the switching fabric and is shared by the VOQs. Only a single data packet from a selected VOQ is transmitted in a given time-step from port-card 205 to switching fabric 105 on data channel 235.

A link scheduler 245 is responsible for selecting among the VOQs in a given port-card or line-card and may use a policy such as round-robin scheduling. In order to eliminate the latency of the request-grant cycle, data packets can be speculatively transmitted in the hope that they will reach the required output port. This can be performed only if the data channel link from the port-card or the line-card to the switching fabric 235 does not have a conflicting data packet transmission in the same time step. An event from the switching system that prompts the queueing system to issue a request for speculative transmission is termed a speculation event trigger. The central scheduler can acknowledge a successful speculative transmission using a SPEC-ACK packet or negative acknowledge a speculative transmission using a SPEC-NAK packet, issued along the control channel 250. This is possible because the central scheduler is responsible for activating the switching fabric for timely passage of data packets and has knowledge of data packets that have been switched through. If speculative passage of a data packet is not feasible, then the data packet will eventually reach the required output port using a regular scheduling request. W. J. Dally et al., “Principles and Practices of Interconnection Networks,” Morgan Kaufman, 2004, pages 316-318, describe state of the art in existing systems in the domain of speculative transmission.

Current systems (for example, see IBM Research Report RZ3650, “Performance of A Speculative Transmission Scheme For Arbitration Latency Reduction”) use a retry or retransmission queue (RTR) along with a VOQ to support regular scheduled arbitration and speculative transmission in an integrated fashion. For example, FIG. 2 shows a retransmission queue RTR1 255 corresponding to Output1 220 and a retransmission queue RTRN 260 corresponding to OutputN 225. The RTR queue is used to queue packets that have been speculatively transmitted but not yet acknowledged by the central scheduler. After speculative transmission, the packet is dequeued from the VOQ and placed in the RTR queue. Queueing a data packet in the RTR queue allows the data packet to be transmitted using regular scheduled arbitration, in case the speculative transmission fails. The idea is to treat the speculative transmission as a ‘best-effort’ try. The system can raise a speculation event trigger to prompt speculative transmission. A retry or retransmission queue (RTR) is needed for every VOQ as shown in FIG. 2. This doubles the state storage requirements in the system, as the RTR queue must be sized equal to a VOQ for a given output port to accommodate data packets that are enqueued in the VOQ and moved to the RTR queue. If there are M ports in a switch and N data packet storage space allocated for every VOQ and RTR queue with a descriptor size of 1 bits, then (M*(2*B)*N) bits are required for storage. For example, if M=64, N=128, B=100, then (64*(100+100)*128) or 1638400 bits are required for storage.

Current systems also employ prioritized transmission of data packets through a switching system. Data packets can be assigned a high priority, a medium priority and a low priority and transmitted through the switching fabric. Each VOQ is usually divided into a high priority VOQ, a medium priority VOQ and a low priority VOQ. Data packets are queued in arrival order in each priority VOQ. Under such circumstances, the central scheduler can reorder requests from a certain VOQ in a line-card or a port-card to maintain priority order. Grants for the VOQ may be transmitted from the central scheduler to the line-card or port-card in a reordered fashion. Moreover, if P priority levels are used by current systems, then one skilled in the art will appreciate that each VOQ and RTR queue will need replication to support priorities. In this case, (P*M*(2*B)*N) bits are required for storage.

In current systems as shown in FIG. 2, for every speculative transmission, two operations are needed. On receiving a speculation event trigger, the VOQ must dequeue the data packet from the VOQ, enqueue this in the RTR queue and then transmit the request corresponding to the data packet to the central scheduler. If a data packet arrives at a certain empty VOQ and the link scheduler 245 has currently selected this queue for a speculation scheduling request due to presence of a speculation event trigger, then arrangements in existing systems are incapable of serving the speculation request. This is because the data packet must first be queued in the VOQ in the current time step and then enqueued in the RTR queue in subsequent time steps. A minimum of three operations is required to handle this situation—a queue in the VOQ, a dequeue from the VOQ and enqueue to the RTR queue. Such arrangements cannot accommodate central schedulers that reorder request responses to meet priority or performance requirements because they use FIFO queues.

In current systems, on receipt of a grant, a check in the RTR queue is required and then a check in the VOQ is performed. These two operations are serialized. Also current systems process grants, SPEC-ACKs and SPEC-NAKs from the central scheduler in a serialized fashion. Serialization of operations can increase queue processing latency in current systems.

Current systems do not preserve the transmission order of regular scheduler requests and speculative transmissions to the central scheduler. Data packets are dequeued from the VOQ and placed in the RTR queue when an opportunity for speculation exists. Both RTR and VOQ are needed to re-construct data packet arrival and scheduler request order. This can make replay of scheduler requests and reliability more complex.

Moreover, the queue arrangement structures in current systems serialize operations and do not lend themselves well to concurrency. Concurrency allows multiple operations to be executed simultaneously. This can increase throughput and also reduce latency. Queueing arrangements in current systems are also memory-inefficient and do not scale well.

Therefore, there is a need for a more efficient, less complex and lower cost ways to arrange queues in a line-card or a port-card of a switching system that promote concurrency, reduce latency and use reduced memory bits to enable processing of regular scheduling requests and speculation requests in an integrated fashion.

### SUMMARY OF THE INVENTION

An aspect of the invention is to provide a method and a system for arranging line-card or port-card queues in a switching or a routing system for reduced memory footprint, high-concurrency and reduced latency.

In order to fulfill the above aspect, the method comprises storing at least one data packet in a virtual output queue (VOQ). In response to storing the data packet in the VOQ, storing an arbitrated-request-reference (AR-reference) corresponding to the at least one data packet in an arbitrated request queue (ARQ). Thereafter, storing a speculative-request-reference (SR-reference) corresponding to the at least one data packet in a speculative request queue (SRQ) in response to storing the AR-reference in the ARQ in case of a speculation event trigger. The method further comprises sending the data packet from the VOQ in response to receiving at least one of a grant of a scheduling request and a speculation event trigger.

Each output port can have a corresponding VOQ, an ARQ and an SRQ in the switching system. A special controller unit allows the VOQ, ARQ and SRQ to be queued in the same time step when a data packet arrives and a speculation event trigger is set. Similarly, a controller corresponding to each VOQ, ARQ and SRQ can dequeue data packets concurrently from each of the three queues. A descriptor cache is used to hide the latency of linked list seeks and de-linking. Further, a speculation request shift register chain is used to recover lost speculation responses and maintain speculation request queue consistency.

### BRIEF DESCRIPTION OF THE DRAWINGS

The foregoing objects and advantages of the present invention for a method for arrangement of line-card or port-card queues in a switching or routing system may be more readily understood by one skilled in the art with reference being had to the following detailed description of several preferred embodiments thereof, taken in conjunction with the accompanying drawings wherein like elements are designated by identical reference numerals throughout the several views, and in which:

FIG. 1 is a block diagram showing a conventional arrangement of a switching system with port-cards, switching fabric and central scheduler/arbiter.

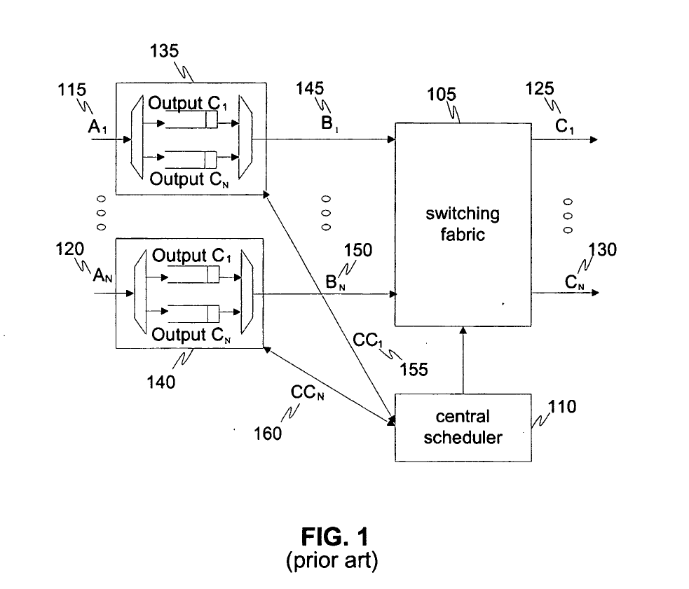

FIG. 2 is a block diagram showing a conventional input port with a link scheduler.

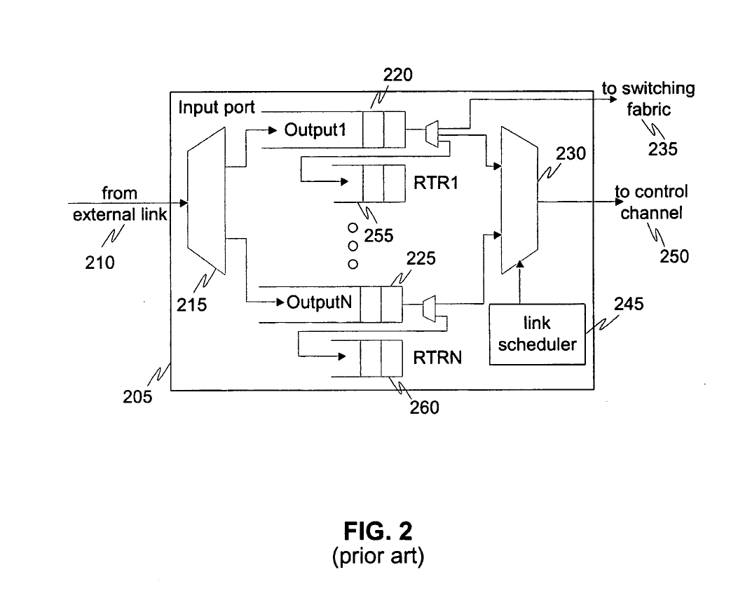

FIG. 3 is a flow diagram for a method of controlling a plurality of queues of an input port in a switching system, in accordance with an embodiment of the present invention.

FIG. 4 is a flow diagram for a method of processing a prioritized data packet, in accordance with an embodiment of the present invention.

FIG. 5 is a flow diagram for a method of controlling a plurality of queues of an input port, in accordance with an embodiment of the present invention.

FIG. 6 is a flow diagram for a method of triggering dequeue in a speculative request queue (SRQ) of the input port, in accordance with an embodiment of the present invention.

FIG. 7 is a block diagram of a system for transmitting at least one data packet in a switching system, in accordance with an embodiment of the present invention.

FIG. 8 is a block diagram depicting a block queue engine, in accordance with an embodiment of the present invention.

FIG. 9 is a block diagram depicting a block request engine, in accordance with an embodiment of the present invention.

FIG. 10 is a block diagram depicting a response parsing engine, in accordance with an embodiment of the present invention.

### DETAILED DESCRIPTION

Before describing in detail embodiments that are in accordance with the present invention, it should be observed that the embodiments reside primarily in combinations of method steps and system components related to a method and system for arranging input queues in a switching or routing system for providing high-concurrency and reduced latency in interconnection networks. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or system that comprises, has, includes, contains a list of elements does not include only those elements but may include other elements not expressly listed or inherent to such process, method, article, or system. An element preceded by “comprises . . . a”, “has . . . a”, “includes . . . a”, “contains . . . a” does not, without more constraints, preclude the existence of additional identical elements in the process, method, article, or system that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and system for arranging input queues in a switching or routing system for providing high-concurrency and reduced latency in interconnection networks described herein. The non-processor circuits may include, but are not limited to, a transceiver, signal drivers, clock circuits and power source circuits. As such, these functions may be interpreted as steps of a method to perform the arrangement of input queues in a switching or routing system for providing high-concurrency and reduced latency in interconnection networks described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention relates to high-speed switching or routing systems used for transmitting data packets from various input ports to various output ports. A series of such data packets at the input ports, waiting to be serviced by the high-speed switching systems is known in the art as a queue. A switching fabric is used to switch data packets from an input port to an output port. A switching fabric can for example be a multi-stage interconnect fabric, a crossbar or cross-point fabric or a shared memory fabric. Crossbar switching fabrics can have a plurality of vertical paths, a plurality of horizontal paths, and optical or electronic means such as optical amplifiers or pass-transistors for interconnecting any one of the vertical paths to any one of the horizontal paths. The vertical paths can correspond to the input ports and the horizontal paths can correspond to the output ports or vice versa, thus connecting any input port to any output port.

The present invention can be used as a fundamental building block in switch line-cards or computer interconnect port-cards for high-performance, high-concurrency and low-latency. Line-cards can be printed circuit boards that provide a transmitting or receiving port for a particular protocol and are known in the art. Line-cards plug into a telco switch, network switch, router or other communications device. The basic idea of the present invention is to use memory-savings and operation reduction to promote memory-efficiency, performance and scalability. Those skilled in the art will realize that the above recognized advantages and other advantages described herein are merely exemplary and are not meant to be a complete rendering of all of the advantages of the various embodiments of the present invention.

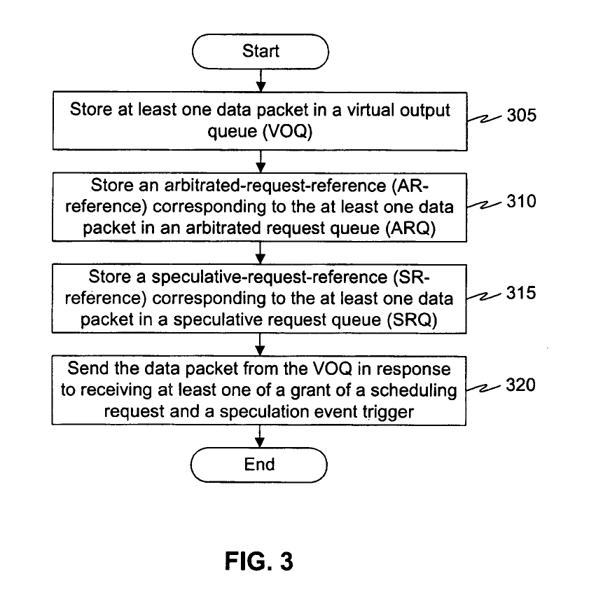

Referring now to the drawings, and in particular FIG. 3, a flow diagram for a method of transmitting at least one data packet in a switching system from a plurality of input ports to a plurality of output ports is shown in accordance with an embodiment of the present invention. The switching system can consist of a data channel and a control channel. A plurality of data packets arrive at a line-card and can be stored in line-card memory. Data packets are appended with suitable information like current queue position index and queued in a VOQ. Data Packets are switched using a switching fabric, while scheduling requests to a central scheduler are made along the control channel using suitable information such as input port identifier, queue length and output port required. Each input port maintains a separate queue for data packets destined for each output port. Such queues are called Virtual Output Queues (VOQs). At step 305, at least one data packet is stored in a VOQ.

Additionally, the queues in the present invention issue requests and collect responses from a switching system central scheduler, also known in the art as an arbiter, that keeps track of output ports that have conflicting requests from different input ports and their order of arrival. Requests for scheduling the data packets can be forwarded along the control channel to the central scheduler. At step 310, indirection is used and a “reference” or a “pointer” to the data packet is stored in the ARQ. Specifically, an arbitrated-request-reference (AR-reference) corresponding to the at least one data packet is stored in an arbitrated request queue (ARQ). AR-reference utilizes lesser storage area than the data packet it corresponds to. Therefore, storing a reference to a data packet in the ARQ rather than storing the data packet itself facilitates storage savings and reduction in critical path length. The AR-reference can be dequeued when a grant from the central scheduler arrives.

The transmission of data packets can be also done speculatively using a speculative request queue (SRQ). In an embodiment of the present invention, during a speculative transmission, indirection is used and a “pointer” to the AR-reference is stored in the SRQ. In this case, a direct enqueue into the SRQ is required instead of a dequeue operation from the ARQ and subsequent storage in the SRQ. Specifically, at step 315, a speculative-request-reference (SR-reference) to the AR-reference corresponding to the data packet is stored in the SRQ in case of a speculation event trigger. The SR-reference will be dequeued when a speculation response or a grant from the central scheduler arrives. In a given time-step, when no data packet transmissions to the switching fabric from a given port-card are underway or the data channel from the port-card to the switching fabric is idle, then a line-card or a port-card can raise a speculation event trigger to prompt transmission of a speculative data packet transmission. Such transmissions are speculative since they do not wait for a grant from the central scheduler to arrive. Those skilled in the art will realize that triggering the queues using a speculation event trigger allows the queueing arrangement to be integrated in a variety of switching and routing systems. The switching system can choose its own method of raising a speculation event trigger, for example by either using local switch information or global information from an interconnection of switches. Alternatively, a switching system could inspect the control channel and raise a speculation event trigger.

One skilled in the art will realize that the indirected queue organization along with the method of queueing the data packet, the AR-reference and the SR-reference described in the method of FIG. 3 are critical to achieving concurrency. One of the critical aspects of this method is that enqueue operations are used for the AR-reference and SR-reference instead of dequeue operations from the VOQ and subsequent enqueue into the ARQ and SRQ respectively.

The present invention also facilitates significant memory saving, since references to the data packets are stored in the ARQ and the SRQ instead of storing the data packets themselves. If there are M ports in a switching system and N data packet storage space allocated for every VOQ with a descriptor size of B bits, then (M*(B*N+2*N*logN)) bits are required for storage, since the size of AR-reference and the SR-reference is logN each, and will be appreciated by those skilled in the art. For example, if M=64, N=128, B=100, then only 64*(128*100+7*128+7*128)=933888 bits are required for storage as against 1638400 bits (M*(2*8)*N) that would be required conventionally where RTR queues are used along with VOQs. In this example, this invention requires only 57% of the storage area required in conventional methods.

When a data packet arrives, it is stored in the VOQ and a request can be issued to the central scheduler. An AR-reference is placed in the ARQ corresponding to the request issued. This action can be completed in the same time-step. Further, if a link scheduler corresponding to the input port where the data packet arrives selects the aforementioned VOQ when a speculation event trigger is raised, an SR-reference is placed in the SRQ and a speculation request is issued to the central scheduler. This can also be completed in the same time-step. If a data packet arrives and a speculation event trigger is raised, all three operations of VOQ enqueue, AR-reference enqueue and SR-reference enqueue can be completed in the same time-step. The time step can be for example, a single clock cycle or a packet time-slot.

At step 320, the data packet is transmitted from the VOQ to the corresponding output port that the data packet is destined for, in response to receiving a grant of a scheduling request or a speculation event trigger.

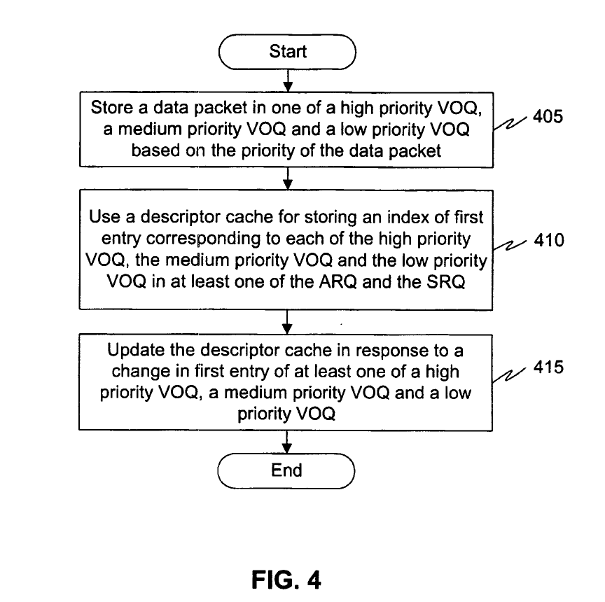

Referring now to FIG. 4, a flow diagram for a method of processing a prioritized data packet is shown in accordance with an embodiment of the present invention. In the embodiment of the present invention, the data packets to be processed are prioritized in a high, medium and low priority order. At step 405, the data packets are stored in a high priority VOQ, a medium priority VOQ or a low priority VOQ based on the priority of the data packets. Further, in an embodiment of the invention, the ARQ and the SRQ can be formed as a unified linked list across high priority, medium priority and low priority data packets. The unified linked list can be, for example, a single flat linked list. The single flat linked list stores data packets from the high priority, the medium priority and the low priority classes. Therefore, eliminating the need for maintaining three different linked lists for each of the high priority, the medium priority and the low priority classes. This simplifies the control logic needed for dequeueing.

At step 410, a cache (for example a register or memory), referred to as a descriptor cache, stores the index of first entry corresponding to each of the high priority VOQ, the medium priority VOQ and the low priority VOQ in the ARQ. In an embodiment of the present invention, the descriptor cache can store the index of first entry corresponding to each of the high priority VOQ, the medium priority VOQ and the low priority VOQ also in the SRQ. At step 415, the descriptor cache is updated in response to a change in first entry of at least one of the high priority VOQ, the medium priority VOQ and the low priority VOQ. In an exemplary embodiment of the present invention, for example, if a first entry corresponding to a high priority VOQ is queued in the ARQ or SRQ, the descriptor cache is updated with the AR-reference or SR-reference value (VOQ index position) corresponding to the first entry. As a result, on grant or speculation response arrival, a dequeue request or a query can be directed to the descriptor cache instead of searching inside the unified linked list of ARQ or SRQ. Therefore, the required entries in the ARQ or the SRQ can be retrieved by directly addressing the descriptor cache. This reduces latency since the descriptor cache can serve the request directly, while linked list seeks to find the required entry and subsequent de-linking can be removed from the critical path.

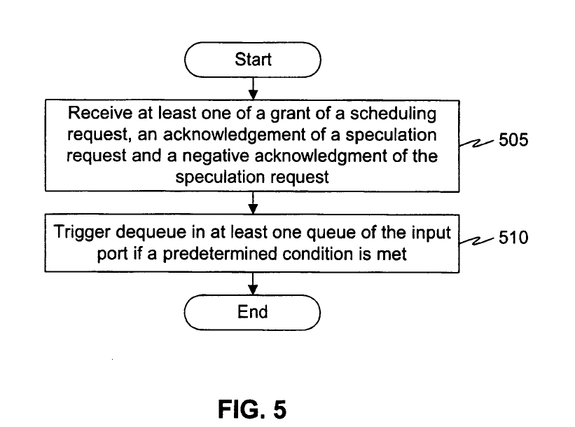

Referring now to FIG. 5, a flow diagram for a method of controlling a plurality of queues of an input port is shown in accordance with an embodiment of the present invention. At step 505, at least one of a grant of a scheduling request, an acknowledgement and a negative acknowledgement of a speculation request is received. In an exemplary embodiment of the present invention, for example, if a grant of a scheduling request for a data packet is received, the data packet is forwarded to the switching fabric and in turn is sent to a corresponding output port.

In response to receiving at least one of the grant of a scheduling request, the acknowledgement and the negative acknowledgement of a speculation request, a dequeue operation corresponding to the VOQ, the ARQ, or the SRQ is initiated. At step 510, a dequeue in at least one queue of the input port is triggered if a predetermined condition is met. In an embodiment of the present invention, the queues can be dequeued in one time step. The time step can be, for example, a single clock cycle. The predetermined condition can comprise a match in first entry of the plurality queues of the input port. Those skilled in the art shall realize that the term “a match” between ARQ and VOQ essentially means that the first entry in the ARQ has the index of the first entry of the VOQ. Similarly a match in VOQ, ARQ and SRQ means that the first entry of the SRQ has the index of the first entry of the ARQ and the first entry of the ARQ has the index of the first entry of the VOQ. In an exemplary embodiment, if a grant of a scheduling request is received, the AR-reference of the head-of-line cell in the ARQ and the head-of-line data packet corresponding to the AR-reference must be dequeued from the VOQ. This is performed only if the head-of-line entries in the VOQ and ARQ match. If the head-of-line SR-reference matches the AR-reference then the SR-reference is also dequeued from the SRQ.

In an embodiment of the present invention, if a grant of a scheduling request is received and if the predetermined condition is met, the VOQ and the ARQ are dequeued. Moreover, if an acknowledgement is received each of the VOQ, the ARQ and the SRQ are dequeued. In another embodiment of the present invention, if a negative acknowledgment is received then only the SRQ is dequeued.

In an embodiment of the present invention, the ARQ and SRQ are configured as First In First Out (FIFO) queues. This accommodates central schedulers that return responses in request order. In another embodiment of the present invention, both the ARQ and SRQ are configured as linked lists with descriptor caches. This accommodates central schedulers that return responses different from request order.

In yet another embodiment of the present invention, entries in the ARQ and SRQ are stored in a unified linked list across high, medium and low priorities. A descriptor cache may be used to reduce data retrieval latency. This accommodates central schedulers that re-order requests to meet data packet priority rules. This is because a FIFO queue can only process responses that are in the same order of requests, while a linked list can process request-reordered responses.

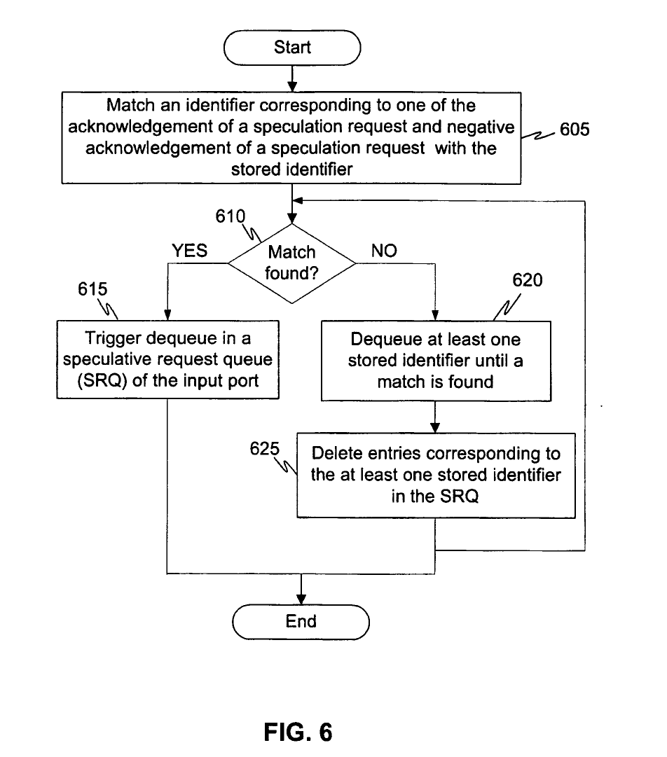

Referring now to FIG. 6, a flow diagram for a method of triggering dequeues in the SRQ of the input port is shown in accordance with an embodiment of the present invention. In addition to the method described in FIG. 5, an embodiment of the present invention further comprises storing an identifier of a speculation request in a shift register chain when a data packet is transmitted speculatively. Those skilled in the art will realize that the shift register chain is sized appropriately to accommodate a control channel round-trip time (RTT). In other words, a speculation request is placed in the leftmost register of the shift register chain after the speculation request is transmitted on the control channel. When a speculation response arrives for the speculation request, the round-trip time sizing ensures that the request is at the rightmost position in the shift register chain. The shift register chain is shifted fight every time-step to meet the aforementioned condition. This enables an identifier corresponding to the speculation response to be matched with the identifier corresponding to the speculation request. At step 605, the stored identifier of the speculation request is matched with a received identifier corresponding to the acknowledgement or the negative acknowledgement for a speculation request. If a match is found at step 610, a dequeue is triggered in an SRQ of the input port at step 615. Further, if the received identifier corresponding to the received acknowledgement or the received negative acknowledgement does not match with the stored identifier at step 610, the stored identifiers are dequeued recursively at step 620 until a match of the received identifier corresponding to the received acknowledgement or the received negative acknowledgement is found. At step 625, in response to dequeueing the stored identifiers at step 620, the entries corresponding to the stored identifiers that are dequeued are deleted from the SRQ. Step 620 and Step 625 can be processed concurrently. Those skilled in the art will realize that this is a simple and efficient way to maintain consistency in the SRQ. In an exemplary embodiment of this invention, if a separate logical channel (also known in the art as a VC or a virtual channel) or physical channel is used for speculation requests and responses on the control channel and the central scheduler returns responses in request order, then a speculation response packet received in error must be a speculation response for the current stored identifier in the rightmost register of the shift register chain. This allows speculation responses to be recovered without retransmissions from the central scheduler. This eliminates a whole round-trip latency on the control channel for retransmission.

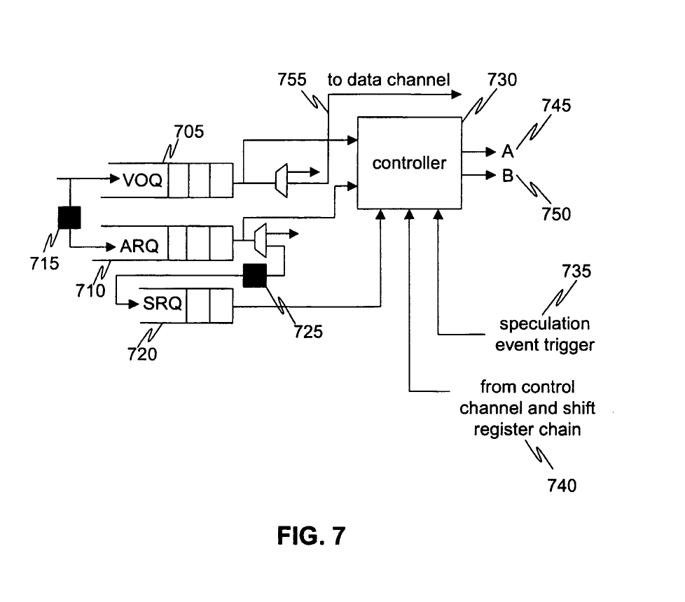

Referring now to FIG. 7, a block diagram of a system for transmitting at least one data packet in a switching system is shown in accordance with an embodiment of the present invention. Those skilled in the art will, however, recognize and appreciate that the specifics of this illustrative embodiment are not specifics of the present invention itself and that the teachings set forth herein are applicable in a variety of alternative settings. The at least one data packet can be transmitted from at least one of a plurality of input ports to at least one of a plurality of output ports. The input port maintains a set of queues corresponding to each output port. These set of queues comprise a VOQ, an ARQ and an SRQ. In other words, there is an ARQ, an SRQ and controller corresponding to each VOQ.

Referring back to FIG. 7, a VOQ 705 corresponds to an output port that the at least one data packet is destined for. The at least one data packet is stored in VOQ 705. An ARQ 710 is an arbiter request queue (ARQ) corresponding to VOQ 705. In response to storing the at least one data packet in VOQ 705, an arbitrated-request-reference (AR-reference) corresponding to the at least one data packet is stored in ARQ 710. Those skilled in the art shall realize that storing a reference to a data packet, for example the AR-reference, instead of the data packet itself facilitates efficient use of memory space in the system. A reference extraction logic block 715 is used to extract relevant information, such as indexes and priority-identifiers from the VOQ 705 entry for placement in the ARQ 710. Those skilled in the art will appreciate that the system may store a data packet directly in the VOQ or a reference to the data packet (for example a ‘descriptor’) in the VOQ.

Further, a speculative request queue SRQ 720 is coupled to ARQ 710. SRQ 720 is used for storing a speculative-request-reference (SR-reference) in response to storing the AR-reference corresponding to the at least one data packet in ARQ 710. During a speculative transmission, indirection is used and only a “reference” or a “pointer” to the AR-reference is stored in SRQ 720. This facilitates storage savings and reduction in critical path length as only a direct enqueue of a reference into SRQ 720 is required instead of a dequeue operation from VOQ 705 or ARQ 710. A reference extraction logic block 725 is used to extract relevant index information, such as indexes and priority-levels from ARQ 710 for queueing in SRQ 720. Those skilled in the art shall appreciate that ARQ 710 and SRQ 720 can also enable recovery of transmission requests made to a central scheduler in the system and also help playback the requests to the central scheduler. For example, if a request is lost in the system, the transmission request can be recovered from ARQ 710 and SRQ 720 since there is an entry in ARQ 710 and SRQ 720 corresponding to each scheduled request and speculation request.

A controller 730 can be used in conjunction with VOQ 705, ARQ 710 and SRQ 720 to process the transmission requests and scheduler responses. Controller 730 acts as a control block which works on a predefined control logic and which can comprise a comparator, that can have inputs as the entries of VOQ 705, ARQ 710 and SRQ 720, a speculation event trigger 735 and an input from the control channel and a shift register chain 740. Controller 730 determines the dequeue and enqueue operations in VOQ 705, ARQ 710 and SRQ 720 on the basis of an output A 745 and an output B 750. Output A 745 can be used to control multiplexers and demultiplexers associated with VOQ 705 and ARQ 710. Output B 750 can be used to control multiplexers and demultiplexers associated with SRQ 720. Controller 730 performs the enqueue and the dequeue operations concurrently in each of VOQ 705, ARQ 710 and SRQ 720 in the same time step. The time step can be for example, a single clock cycle or a packet time-step.

In an exemplary embodiment of the present invention, for example, on receiving a grant corresponding to a scheduled request for a data packet from control channel and shift register chain 740, if the data packet in VOQ 705 matches with the AR-references in ARQ 710, output A 745 dequeues the data packet from VOQ 705 and the corresponding AR-reference from ARQ 710 and the data packet is forwarded to the switching fabric over data channel 755. The respective entries in VOQ 705 and ARQ 710 can be dequeued by controller 730 in a single time step.

In another exemplary embodiment of the present invention, if speculation event trigger 735 is received, output B 750 enqueues a SR-reference in SRQ 720 corresponding to an AR-reference in ARQ 710. Output A 745 allows transmission of a data packet from VOQ 705 along the data channel 755 to the switching fabric. Further, if an acknowledgment from control channel and shift register chain 740 is received corresponding to a speculation request for a data packet and if the SR-reference in SRQ 720 matches with the AR-reference in ARQ 710 and the corresponding index of the data packet in VOQ 705, output A 745 dequeues the data packet from VOQ 705 and the corresponding AR-reference from ARQ 710. Output B 750 dequeues the corresponding SR-reference from SRQ 720. The respective entries in VOQ 705, ARQ 710 and SRQ 720 are dequeued by controller 730 in a single time step.

Further, if a negative acknowledgement for a speculation request is received from control channel and shift register chain 740 and the SR-reference in SRQ 720 matches with the AR-reference in ARQ 710 and the corresponding data packet in VOQ 705 then output B 750 dequeues the SR-reference from SRQ 720. However, the corresponding data packet and its AR-reference are not dequeued from VOQ 705 and ARQ 710, since the data packet still needed to be transmitted.

In the embodiment of the present invention, the data packets to be processed can be prioritized. The data packets can be processed in a high priority, medium priority and low priority order. VOQ 705 can comprise a high priority VOQ, a medium priority VOQ and a low priority VOQ. Further, ARQ 710 and SRQ 720 can be formed as a unified linked list across the high priority, the medium priority and the low priority classes. The unified linked list stores the high priority, medium priority and low priority classes in request order to the central scheduler. A system corresponding to this embodiment of the present invention can further comprise a descriptor cache, as mentioned earlier, for storing the index of first entry corresponding to each of the high priority VOQ, the medium priority VOQ and the low priority VOQ in ARQ 710. SRQ 720 can be a linked list for example, that stores entries corresponding to high, medium and low priority entries. Those skilled in the art shall realize that a unified linked list enables logic saving and increases compactness in the system. A unified linked list allows responses from the central scheduler to be processed in an order different from the initial request order. A FIFO would limit responses to be processed in the same order as requests. This is to accommodate a central scheduler that re-orders requests to meet priority needs.

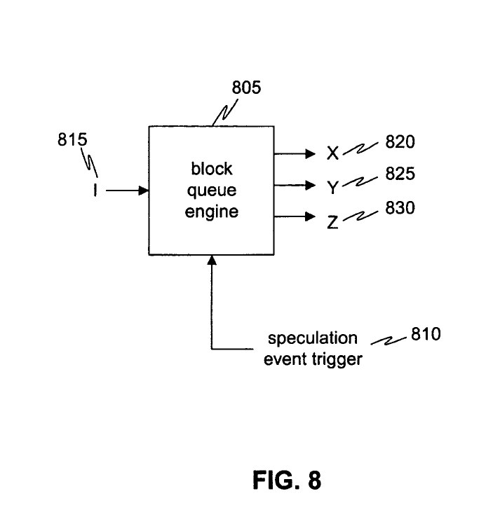

Referring now to FIG. 8, a block diagram depicting a block queue engine is shown in accordance with an embodiment of the present invention. A block queue engine 805 can be introduced in the system depicted in FIG. 7 for concurrently placing a data packet in VOQ 705, an AR-reference in ARQ 710 and an SR-reference in SRQ 720 in case of a speculation event trigger 810. Block queue engine 805 can comprise a reference extraction logic block described in FIG. 7.

The input to the block queue engine 805 is the data packet 1815. An output X 820 comprises the data packet and is an input to VOQ 705. An output Y 825 can comprise an AR-reference corresponding to the data packet and can be placed in ARQ 710. Similarly, an output Z 830 can comprise an SR-reference corresponding to the AR-reference and can be placed in SRQ 720. As the data packet, the AR-reference and the SR-reference are placed concurrently in one time step, it requires only one operation and therefore latency in the system can be minimized.

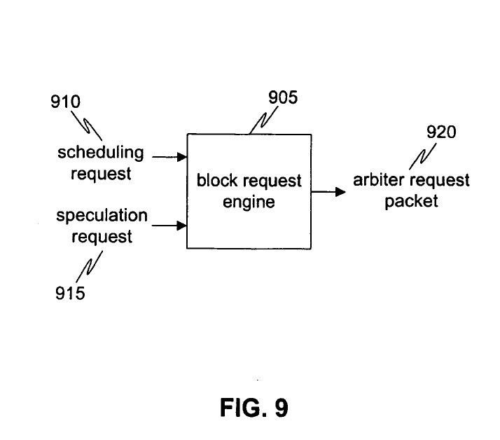

Referring now to FIG. 9, a block diagram depicting a block request engine is shown in accordance with an embodiment of the present invention. A block request engine 905 enables combining a scheduling request 910 and a speculation request 915, which are transmitted on the control channel of the input ports, into an arbiter request packet 920. Arbiter request packet 920 is then forwarded to a central scheduler that is coupled to a switching fabric for further arbitration. This allows regular scheduling requests and speculation requests to be combined and completed in the same time-step. This increases request throughput of the system.

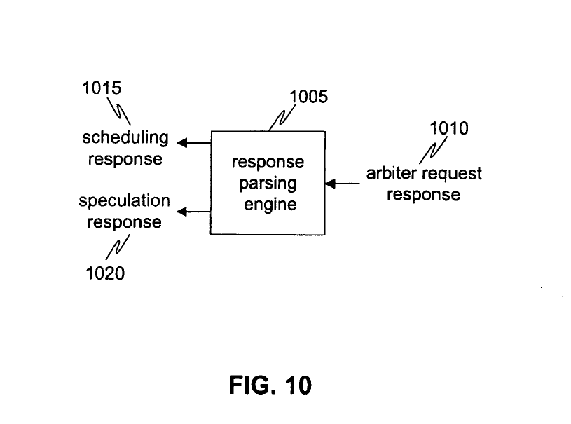

Referring now to FIG. 10, a block diagram depicting a response parsing engine is shown in accordance with an embodiment of the present invention. A response parsing engine 1005 receives an arbiter request response 1010 in response to arbiter request packet 920 described in FIG. 9. Arbiter request response 1010 can comprise a scheduling response 1015 and a speculation response 1020. Response parsing engine 1005 segregates scheduling response 1015 and speculation response 1020 from the combined and merged arbiter request response 1010. Scheduling response 1015 and speculation response 1020 are then delivered to controller 730 for further processing. In an embodiment of the current invention, controller 730 can process the combined scheduling response 1015 and speculation response 1020 concurrently and can complete dequeue operations in ARQ 710 or SRQ 720 in the same time-step. In addition, both responses can be issued to queue sets (VOQ 705, ARQ 710 and SRQ 720) that correspond to different output ports.

The various embodiments of the present invention provide a method and system that controls the transmission of at least one data packet in a switching system from a plurality of input ports to a plurality of output ports. Further, the various embodiments of the present invention provide a method and system for arranging the data packets in an integrated virtual output queue (I-VOQ) with VOQ, ARQ and SRQ that can support packet priorities. Storing references, not only reduces the memory needs of the system, but also reduces the operations needed for completing a scheduling request or speculation request. Also, the various embodiments of this invention allow interaction with central schedulers that reorder scheduling or speculative transmission requests using linked lists.

In the present invention, priority queues can be unified in a linked list with special hardware cache structures to support compact and efficient queue arrangement. Also, enqueue of references is sufficient, without a dequeue and subsequent enqueue to another queue. If a data packet arrives at a certain empty VOQ and the link scheduler has currently selected this queue for a speculation scheduling request due to presence of a speculation event trigger, then the present invention is capable of serving the speculation request in only one operation as against a minimum of three operations required conventionally. A descriptor cache reduces seek and de-linking latency when the central scheduler reorders requests and a unified linked list is needed. A queue controller allows descriptor and reference dequeueing to be completed concurrently in the same time-step. If a grants acknowledgement or negative acknowledgement arrives then the dequeue operations needed for VOQ, ARQ and SRQ can be completed in the same time step.

The present invention also provides for separate link schedulers for regular scheduling requests and speculation scheduling requests. This allows a regular scheduling request and a speculation scheduling request from the same or different VOQ to be combined on the same request to the central scheduler. Therefore, scheduling responses and speculation responses to different VOQs can be handled concurrently. A block queueing engine allows a regular scheduler request and speculative transmission scheduler request to be processed concurrently when a data packet arrives and a speculation event trigger is raised in the system. Block request and parsing engines allow regular requests and speculation requests to be processed concurrently in an integrated fashion. This invention uses an arrangement that reduces memory and exposes parallelism to enable operation concurrency. This increases system throughput and also reduces critical path length, thereby reducing latency. Storing and recording every scheduler request in order by using references allows error recovery, this can facilitate playback of requests to the scheduler, in case a system error occurs. The speculation request shift-register chain helps maintain consistency of the queues for playback. It also reduces latency by recovering data corresponding to lost speculation responses and avoiding costly retransmissions.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A system for transmitting at least one data packet in a switching system from a plurality of input ports to a plurality of output ports, the system comprising a plurality of queues placed in the plurality of input ports, wherein the plurality of queues comprises:
a. at least one virtual output queue (VOQ) for storing at least one data packet;
b. an arbitrated request queue (ARQ) for storing an arbitrated-request-reference (AR-reference) corresponding to the at least one data packet, an AR-reference to a data packet being stored in the ARQ in response to storing the data packet in a VOQ; and
c. a speculative request queue (SRQ) for storing a speculative-request-reference (SR-reference) corresponding to the at least one data packet, an SR-reference to an AR-reference being stored in the SRQ in response to storing the AR-reference in the ARQ in case of a speculation event trigger.

2. The system of claim 1, wherein the at least one VOQ comprises a high priority VOQ, a medium priority VOQ and a low priority VOQ, and the ARQ is a linked list wherein a data packet is stored in the at least one VOQ depending on the priority, and the system further comprises a descriptor cache for storing the index of first entry corresponding to each of the high priority VOQ, the medium priority VOQ and the low priority VOQ in the ARQ.

3. The system of claim 2, wherein the SRQ is a linked list.

4. The system of claim 1, further comprising a block queueing engine for placing concurrently a data packet in the VOQ, an AR-reference in the ARQ and an SR-reference in the SRQ in case of a speculation event trigger.

5. The system of claim 1, further comprising a block request engine for sending a scheduling request and a speculation request on an arbiter request packet in the same time step.

6. The system of claim 1, further comprising a response parsing engine for segregating a scheduling response and a speculation response from an arbiter request response in the same time step

7. The system of claim 1 further comprising:
a controller corresponding to at least one input port, wherein the controller is configured to:
i. receive at least one of a grant of a scheduling request, an acknowledgement of a speculation request and a negative acknowledgment of a speculation request; and
ii. trigger dequeueing in at least one queue of the at least one input port, wherein the at least one queue is dequeued in one time step with plurality of queues dequeued concurrently in the same time step.

8. The system of claim 7, wherein if the controller receives the grant of a scheduling request, the controller is configured to trigger dequeueing in at least two queues of the at least one input port in case a predetermined condition is met, wherein the at least two queues comprises the VOQ and ARQ, wherein the predetermined condition comprises a match in first entry of the at least two queues.

9. The system of claim 7, wherein if the controller receives the acknowledgement of a speculation request, the controller is configured to trigger dequeueing in each queue of the at least one input port in case a predetermined condition is met, wherein the predetermined condition comprises a match in first entry of each queue.

10. The system of claim 7, wherein if the controller receives the negative acknowledgment of a speculation request, the controller is configured to trigger dequeueing in the SRQ of the at least one input port in case a predetermined condition is met, wherein the predetermined condition comprises a match of the first entry of VOQ and ARQ with first entry of the SRQ of the at least one input port.

11. The system of claim 7 further comprising a shift register chain corresponding to the at least one input port, wherein an identifier corresponding to each speculation request sent from an input port is stored in the shift register chain.

12. The system of claim 11, wherein to trigger dequeueing, the controller is configured to:
a. match an identifier corresponding to one of the acknowledgement of the speculation request and negative acknowledgement of the speculation request with the stored identifier; and
b. trigger dequeue in the SRQ of the at least one input port if the identifier corresponding to one of the acknowledgement of the speculation request and negative acknowledgement of the speculation request matches with the stored identifier.

13. The system of claim 12, the controller is further configured to:
a. dequeue at least one stored identifier recursively until a match of the identifier corresponding to one of the received acknowledgement of the speculative transmission request and received negative acknowledgement of the speculative transmission request is found; and
b. delete entries corresponding to the at least one stored identifier in the SRQ in response to recursive dequeue of the at least one stored identifier.

14. A method of controlling a plurality of queues of an input port, the method comprising:
a. receiving at least one of a grant of a scheduling request, an acknowledgement of a speculation request and a negative acknowledgment of the speculation request; and
b. triggering dequeue in at least one queue of the input port if a predetermined condition is met, wherein the at least one queue is dequeued in one time step with plurality of queues dequeued concurrently in the same time step, and the predetermined condition comprises a match in first entry of the plurality of queues of the input port.

15. The method of claim 14, further comprising storing an identifier of a speculation request in a shift register chain when a data packet is transmitted speculatively, wherein the step of triggering comprises:
a. matching an identifier corresponding to one of the acknowledgement of a speculation request and negative acknowledgement of a speculation request with the stored identifier; and
b. triggering dequeue in a speculative request queue (SRQ) of the input port if the identifier corresponding to one of the acknowledgement of a speculation request and negative acknowledgement of a speculation request matches with the stored identifier.

16. The method of claim 15 further comprising:
a. dequeueing at least one stored identifier recursively until a match of the identifier corresponding to one of the received acknowledgement of a speculation request and received negative acknowledgement of a speculation request is found; and
b. deleting entries corresponding to the at least one stored identifier in the SRQ in response to recursive dequeue of the at least one stored identifier.

17. A method for transmitting at least one data packet in a switching system from a plurality of input ports to a plurality of output ports, the method comprising:
a. storing at least one data packet in a virtual output queue (VOQ);
b. storing an arbitrated-request-reference (AR-reference) corresponding to the at least one data packet in an arbitrated request queue (ARQ), an AR-reference to a data packet being stored in the ARQ in response to storing the data packet in the VOQ;
c. storing a speculative-request-reference (SR-reference) corresponding to the at least one data packet in a speculative request queue (SRQ), an SR-reference to a AR-reference being stored in the SRQ in response to storing the AR-reference in the ARQ in case of a speculation event trigger; and
d. sending the data packet from the VOQ in response to receiving at least one of a grant of a scheduling request and a speculation event trigger.

18. The method of claim 17, further comprising controlling each queue of the input port based on receiving at least one of a grant of a scheduling request, an acknowledgement of a speculation request and a negative acknowledgment of a speculation request.

19. The method of claim 17, wherein to process a data packet having one of a high, medium and low priority, the data packet is stored in one of a high priority VOQ, a medium priority VOQ and a low priority VOQ based on the priority of the data packet.

20. The method of claim 19, wherein at least one of the ARQ and the SRQ is a linked list, wherein a descriptor cache is used for storing an index of first entry corresponding to each of the high priority VOQ, the medium priority VOQ and the low priority VOQ in at least one of the ARQ and the SRQ, and the descriptor cache is used to directly retrieve entries corresponding to the high priority VOQ, the medium priority VOQ and the low priority VOQ in the at least one of the ARQ and the SRQ, wherein the descriptor cache is updated in response to a change in first entry of at least one of a high priority VOQ, a medium priority VOQ and a low priority VOQ.
